(19) United States
(12) Patent Application Publication
(10) Pub. No.: US 2025/0270059 A1
(43) Pub. Date: Aug. 28, 2025

(54) CONVEYING DEVICES FOR BULK MATERIAL, SYSTEM COMPRISING A CONVEYING DEVICE OF THIS TYPE AND METHOD FOR CLEANING A CONVEYING DEVICE

(71) Applicant: Qlar Europe GmbH, Darmstadt (DE)

(72) Inventors: Peter Schweizer, Darmstadt (DE); Andreas Mueller, Riedstadt (DE)

(73) Assignee: Qlar Europe GmbH, Darmstadt (DE)

(21) Appl. No.: 19/201,890

(22) Filed: May 7, 2025

Related U.S. Application Data
(63) Continuation of application No. PCT/EP2023/080916, filed on Nov. 7, 2023.

(30) Foreign Application Priority Data
Nov. 7, 2022 (DE) 102022129283.5

(51) Int. Cl. B65G 45/22; B29C 48/285; B65G 45/00

(52) U.S. Cl. CPC B65G 45/22; B65G 45/005; B29C 48/286

(57) ABSTRACT

A dispensing device for bulk material, a system comprising a dispensing device and a method for cleaning a dispensing device are provided. The conveying device for bulk material includes at least one pick-up unit for picking up bulk material to be dispensed. At least one discharge area is downstream of the pick-up unit in a main conveying direction and/or into which bulk material can be relocated from the pick-up unit, in particular, via a bulk material outlet opening of the pick-up unit. A discharge element is provided within the discharge area for discharging the bulk material from the discharge area in a direction of a discharge opening of the device. At least one nozzle is provided for blowing fluid into an area existing around the discharge element.

This nonprovisional application is a continuation of International Application No. PCT/EP2023/080916, which was filed on Nov. 7, 2023, and which claims priority to German Patent Application No. 10 2022 129 283.5, which was filed in Germany on Nov. 7, 2022, and which are both herein incorporated by reference.

### BACKGROUND OF THE INVENTION

### Field of the Invention

The present invention relates to conveying devices for bulk material, to a system comprising such a conveying device and to a method for cleaning a conveying device.

### Description of the Background Art

Conveying devices for conveying bulk material as well as conveying devices as part of dispensing devices for dispensing bulk material are known from the state of the art. In this process, the bulk material to be conveyed or dispensed is conveyed from a pick-up unit, such as a container, into a discharge area downstream of the pick-up unit in the main conveying direction, from where the bulk material to be conveyed or dispensed is discharged from the device by means of a discharge element. In a dispensing device, the discharge takes place in a defined quantity, and a distinction is usually made between gravimetric and volumetric dispensing. Typically, cleaning of the device is necessary, especially when changing the type of bulk material, in order to avoid cross-contamination of the bulk material.

However, cleaning such a conveying device and its parts is time-consuming and costly. Therefore, cleaning measures are carried out as rarely as possible and frequent changes of bulk material type are avoided to avoid cross-contamination. However, this may impair the performance of the device and make it difficult to achieve the highest possible utilization of the device.

### SUMMARY OF THE INVENTION

It is therefore the object of the present invention to overcome the described disadvantages of the prior art and in particular to specify means which make it possible to carry out efficient and economical cleaning of a conveying device for conveying bulk material or a conveying device as part of a dispensing device for dispensing bulk material.

The object is achieved by the invention according to a first aspect by providing a conveying device for bulk material having the features of claim 1. The conveying device has at least one pick-up unit for picking up bulk material to be conveyed and at least one discharge area that follows the pick-up unit in the main conveying direction and/or into which bulk material can be displaced from the pick-up unit, in particular via a bulk material outlet opening of the pick-up unit. The conveying device also has a discharge element located within the discharge area, which is provided for discharging the bulk material from the discharge area towards a discharge opening of the device. According to the invention, a nozzle is provided for blowing fluid into an area existing around the discharge element.

Alternatively or additionally, it may be provided that the discharge element is arranged in an overhung position within the discharge area. The discharge element can also be or have a screw, a chute, a worm, a spiral, a clearing arm, a lock wheel, a cell wheel, a rotary valve, a sluice, and/or a roller.

The invention is thus based on the surprising finding that settled and/or adhering bulk material residues, supported by a fluid flow formed in the area of the discharge element, can be removed particularly reliably and easily from parts of the dispensing device that come into contact with the bulk material and be transported away in the main conveying direction. Especially hard-to-reach areas of the dispensing device can be cleaned of bulk material residues by blowing in a fluid by means of nozzles and thus detaching the stuck bulk material.

This can advantageously reduce the cleaning time and/or clean the device of larger quantities of settled and/or adhering bulk material in the same or even less time.

Above all, the inventors recognized that the use of the proposed cleaning concept could be carried out without manual intervention. This means that cleaning can also be carried out programmatically and automatically if necessary. This not only enables flexible cleaning cycles, but also significantly reduces the comparatively high costs and long downtimes associated with cleaning conveying and dispensing devices.

Above all, thanks to the proposed concept, the conveying device no longer needs to be opened by a cleaner for cleaning or manually freed from the settled and/or adhering bulk material. This means that conveying devices that are used to convey or dispense hazardous bulk material can also be safely cleaned. This, in turn, can increase occupational safety for the people involved. There are also no additional or fewer stringent safety requirements associated with cleaning, as no people need to be protected from contact with bulk material during cleaning. All these advantages can significantly reduce maintenance and operating costs of the conveying and dispensing device.

In an advantageous embodiment, the conveying device has nozzles at different points around the discharge element. For example, it may be provided to blow fluid into a coupling area where the discharge element is connected to a drive element, such as a drive shaft.

An additional nozzle or nozzles may be provided for blowing fluid into a dead space below the discharge element and/or for blowing fluid into the radially existing area between a shaft, or a hollow shaft, of the discharge element and an inner surface of a housing forming the discharge area.

Advantageously, the nozzle or nozzles may be located on or in a bearing element for bearing the discharge element and/or on or in a shaft of the discharge element. Depending on their arrangement and orientation, the fluid can be ejected along a direction perpendicular to the direction of gravity or parallel to the main extension direction of the discharge element. In addition, the fluid can be ejected along a direction perpendicular to the main extension direction of the discharge element and/or deflected in a direction parallel to the main extension direction.

An example provides that the nozzle or nozzles eject the fluid along a direction radially to the main extension direction of the discharge element.

In particular, it has been surprisingly recognized that the discharge element can advantageously remain installed during cleaning and can be used to swirl the fluid flow introduced by the nozzle or nozzles. Thus, the cleaning effect can be surprisingly significantly increased by the presence of the discharge element.

The coupling area can be an area separated from the discharge area and/or at least partially separated. In this case, too, cleaning with the suggested nozzle is efficient and particularly easy and thorough. Especially if any bulk material stuck in the coupling area cannot be discharged through the discharge element, the proposed solution is particularly suitable for efficient and thorough cleaning.

The coupling area can be part of a bearing element for bearing the discharge element.

In addition, impairments of the discharge element by stuck bulk material, also and especially in the coupling area, can be avoided or at least reduced by providing one or more of the proposed nozzles.

In one embodiment, it may also be advantageous that the device is designed to actuate, in particular rotate, the discharge element at least temporarily while ejecting a fluid jet through the nozzle or nozzles. In this way, a beneficial cleaning effect was observed both in the discharge area and with regard to the pick-up unit alone.

Alternatively or in addition, the first and/or second aspect of the invention may also provide at least two nozzles with which fluid can be blown into the area around the discharge element, in particular into the dead space, in two opposite directions, preferably at least one nozzle being provided at each of the two ends of the discharge area.

This means that even an extensive discharge area can be cleaned particularly advantageously.

An example provides that a conveying device for bulk material is provided, which device has at least one pick-up unit for picking up bulk material to be dispensed and at least one additional nozzle for ejecting a fluid jet into the pick-up unit, at least temporarily, wherein the additional nozzle is aligned in such a way that an inner surface of the pick-up unit can be at least partially flowed against by the fluid jet, for the formation of a fluid flow in the manner of a cyclone as a cleaning fluid flow, in particular, at least within the pick-up unit and/or at least in some areas.

The invention is thus based on the surprising finding that settled and/or adhering bulk material residues, supported by a fluid flow formed within the pick-up unit, can be removed particularly reliably and easily from parts of the conveying device that come into contact with the bulk material and be transported away in the main conveying direction. By forming this fluid flow, known as the cleaning fluid flow, in the manner of a cyclone, at least within the pick-up unit, this fluid flow can surprisingly achieve a particularly high efficiency in the cleaning of the dispensing device and its parts. This can advantageously reduce the cleaning time and/or clean the device of larger quantities of settled and/or adhering bulk material in the same or even less time.

In an advantageous embodiment, the conveying device has at least two or more than two additional nozzles, each for the at least temporary ejection of a fluid jet into the pick-up unit, wherein advantageously each of these additional nozzles is aligned in such a way that each of several areas of the inner surface of the pick-up unit at least partially flow against the respective fluid jet, in order to form a fluid flow in the manner of a cyclone as a cleaning fluid flow within the pick-up unit, at least in some areas.

When, in the present application, it is said in the context of the cleaning fluid flow that this is “in the manner of a cyclone”, it is preferably understood to mean (a) that the cleaning fluid flow (i) represents a vortex flow, in particular three-dimensional and/or turbulent, and/or (ii) performs a rotational movement about a central axis of the pick-up unit and/or (b) that fluid components that have settled due to the centripetal force, in particular denser fluid components, such as cleaning granules, move along, and especially with contact to, the inside of the pick-up unit, which can preferably increase the cleaning effect.

The invention thus takes advantage of the fact that bulk material residues located on the inner surface of the pick-up unit can be transported away and also removed particularly reliably by means of a fluid flow or vortex flow. The removed bulk material residues can then be discharged from the device. For example, they can be removed from the device by the discharge element moving them mechanically or by applying a negative pressure and sucking out the removed bulk material residues.

This makes it possible to change the type of bulk material in a short time, which can improve the utilization of the conveying device. In particular, cross-contamination can be avoided or at least significantly reduced. Electrostatically charged bulk material residues can also be effectively removed with the proposed concept.

In an advantageous embodiment, the ejection from a nozzle takes place for a period of 1 second or longer, preferably 10 seconds or longer, preferably 30 seconds or longer, preferably 60 seconds or longer, and/or 100 seconds or shorter, preferably 60 seconds or shorter. Optionally, the nozzles are configured for a correspondingly long fluid output.

Preferably, the bulk material to be dispensed is a powdery, granular, or lumpy mixture that is or can be present in a pourable form.

Examples of an advantageous bulk material are rock, building materials, in particular topsoil, sand, gravel and/or cement; raw materials, in particular ore, coal, clay and/or road salt; foodstuffs, in particular cereals, sugar, salt, coffee and/or flour; and/or powdered goods, in particular pigments, fillers, granules and/or pellets.

The fluid of the fluid jet ejected by a nozzle may be, for example, an alcohol, water, a gas, in particular an inert gas or hydrogen, or a mixture of gases, such as air, in particular compressed air.

The fluid may advantageously be ejected from the first nozzle at an absolute pressure of more than 5 bar, preferably more than 10 bar, preferably more than 20 bar.

The main conveying direction runs advantageously from the pick-up unit towards the bulk material outlet opening.

Alternatively or in addition, it may also be provided that the pick-up unit has a lid, in particular a removable one, and preferably the bulk material feed opening is provided in the lid.

The pick-up unit can be securely closed by the lid. And thanks to a bulk material feed opening provided in the lid, the dispensing device can be operated safely, as the inside of the pick-up unit cannot be accidentally touched during the dispensing and/or cleaning operation. For example, for maintenance work on the device, the lid can simply be removed for better accessibility to the inside of the pick-up unit.

It may also be provided that the bulk material outlet opening is opposite the bulk material feed opening or that the bulk material feed opening and the bulk material outlet opening have a common central axis. The central axes of the bulk material feed opening and bulk material outlet opening can be different and preferably run parallel or inclined to each other.

Alternatively or additionally, it may also be provided that the pick-up unit, in particular at least in some areas, is rotationally symmetrical.

This makes the pick-up unit particularly easy to use. And a cyclone-style flow can be formed particularly advantageously.

Alternatively or in addition, it may also be provided that the pick-up unit has or represents a container and/or, in particular at least in some areas, such as in an inner part of the pick-up unit, is designed in a hollow-truncated conical shape.

Alternatively or additionally, it may also be provided that the inner surface of the pick-up unit is and/or can be brought in contact with the bulk material at least temporarily during the dispensing operation of the device and/or wherein the inner surface is formed at least in part as a lateral surface of a truncated cone.

Alternatively or additionally, it may also be provided that the pick-up unit has a diameter, in particular an inner diameter, that tapers along the direction of gravity, at least in sections.

Because the pick-up unit is hollow-truncated and conical/or has a decreasing diameter, a pronounced vortex flow can be formed within the pick-up unit particularly efficiently and reliably and the spiral course of the fluid flow already mentioned above can be achieved.

Alternatively or in addition, it may also be provided that the additional nozzle is aligned, in particular relative to the pick-up unit, preferably with the inner surface of the pick-up unit, in such a way that the fluid jet ejected from the additional nozzle can be deflected by means of an impact area on the inner surface of the pick-up unit.

The deflection can advantageously be at least partially carried out along a direction of curvature of the inner surface, which direction of curvature corresponds to a direction of rotation of the pick-up unit.

Alternatively or in addition, it may also be provided that the inner surface has a curved course along at least one circumferential direction of the pick-up unit, at least in some areas, preferably everywhere, and preferably that the course of the impact area, in particular completely or at least partially, is determined by the curved course.

Alternatively or in addition, it may also be provided that the additional nozzle is aligned, in particular relative to the pick-up unit, preferably to the inner surface of the pick-up unit, in such a way that the fluid jet ejected from the additional nozzle has a tangential, horizontal first velocity component at the impact effort on the inner surface, in particular at the impact area, and that in particular the first velocity component is greater than a second velocity component that is parallel to the direction of gravity of the fluid jet ejected by the first nozzle.

Thus, the formation in the manner of a cyclone can result advantageously from the interaction between the additional nozzle, especially its position and orientation, and the pick-up unit, especially the inner surface of the pick-up unit.

Alternatively or additionally, it may also be provided that the additional nozzle protrudes partially and/or temporarily into the pick-up unit, at least during the conveying, dispensing, and/or cleaning operation of the device.

Alternatively or additionally, it may also be provided that the additional nozzle is arranged on the lid of the pick-up unit, in particular in such a way that, when the lid is closed, the additional nozzle protrudes at least partially into the pick-up unit.

This means that existing conveying and dispensing devices are also particularly economical and can be retrofitted with little effort, as only the lid needs to be equipped with a corresponding additional nozzle. By the additional nozzle being provided on the lid, the necessary modifications to existing conveying devices are limited to a few parts that can be easily retrofitted.

Alternatively or additionally, it may also be provided that the additional nozzle is arranged on the inner surface of the pick-up unit, in particular in such a way that the additional nozzle protrudes at least partially into the pick-up unit.

Alternatively or additionally, it may also be provided that the additional nozzle is arranged in the pick-up unit, in particular at least during the conveying, dispensing and/or cleaning operation of the device, in such a way that it is positioned above a fill level defined relative to a maximum level of bulk material in the pick-up unit that is permitted during the dispensing operation of the dispensing device.

This is particularly advantageous, as it avoids or at least significantly reduces contamination of the additional nozzle with bulk material during the conveying operation of the device. This can avoid manual intervention to clean the additional nozzle itself or at least be kept to a minimum.

Alternatively or in addition, it may also be provided that residues of the bulk material can be removed from the inner surface of the discharge area and/or the pick-up unit by means of the fluid flow and cleaning fluid flow and/or that residues of the bulk material removed from the inner surface of the discharge area and/or pick-up unit can be transported in the direction of the bulk material outlet opening and/or the discharge opening.

This makes it particularly easy and reliable to remove the bulk material residues from the device.

Alternatively or in addition, it may also be provided that the device has a storage container for the storage of a cleaning agent, in particular a granular cleaning agent, such as cleaning granules, and/or is connected or can be connected to such a storage container.

By using a cleaning agent, the cleaning effect of the cleaning fluid flow can be further increased, and the cleaning result can be improved. Therefore, it is advantageous if the device has an appropriate storage container.

For example, a granulate, in particular a low-elastic, organic and/or inorganic one, such as granules comprising or consisting of polyethylene and/or polypropylene, may be provided as a cleaning agent. It is particularly advantageous to use materials as cleaning agents that are processed elsewhere in the process and are therefore available.

Alternatively or in addition, it may also be provided that the device, in particular in the lid of the pick-up unit, has a cleaning agent feed opening for feeding the cleaning agent, in particular from the storage container, into the interior of the pick-up unit.

This means that the cleaning agent can be fed into the dispensing device particularly safely. For example, the cleaning agent can be fed from the storage container into the interior of the pick-up unit via a connecting hose that opens into the cleaning agent feed opening or passes through it.

Alternatively or additionally, it may also be provided that the additional nozzle and/or the cleaning agent feed opening is/are offset from a defined or definable vertical central plane of the pick-up unit.

This allows for the additional nozzle to be positioned particularly close to the inner surface/the impact area. In this way, the cleaning fluid flow can be formed particularly reliably.

For example, the center plane can comprise a vertical center axis of the pick-up unit.

It is understood that the middle plane can be a purely mental auxiliary construction and does not necessarily have to be present as a physical feature.

Alternatively or in addition, it may also be provided that the device is set up to supply the cleaning agent, in particular from the storage container and/or via the bulk material feed opening and/or the cleaning agent feed opening, to the fluid flow, preferably after stable formation of the cleaning fluid flow in the manner of a cyclone.

In particular, the cleaning agent is only added into the interior of the pick-up unit after the start of the supply of fluid. This two-stage process can achieve a reliable formation of the flow on the one hand and on the other hand can first remove residues of the bulk material that are easily removed before the remaining residues are removed under the influence of the cleaning agent.

Alternatively or in addition, it may also be provided that the device is set up to supply the emitted fluid jet and/or the cleaning fluid flow with the cleaning agent that can preferably be carried along with the cleaning fluid flow, at least temporarily and/or at least in sections.

In the first option, the cleaning agent is already added to the fluid that the additional nozzle emits. This allows for a particularly compact design of the device to be achieved, as no additional openings are required to feed the cleaning agent into the pick-up unit. The cleaning agent can be permanently or at least temporarily mixed with the fluid to be emitted as a fluid jet. For example, the cleaning agent can be added to the fluid with a time delay, so that a two-step process can be carried out as described above.

Alternatively or additionally, it may also be provided that the cleaning agent can be fed to the pick-up unit via a separate opening and/or via the same opening as the bulk material.

Alternatively or additionally, it may also be provided that the lid of the pick-up unit has the cleaning agent feed opening.

Alternatively or in addition to the above-mentioned aspects of the invention, it may also be provided that the discharge opening terminates into a discharge element, in particular having a nozzle, a vertical discharge and/or a downpipe, wherein bulk material is preferably discharged from the dispensing device via the discharge element in a direction parallel or inclined, in particular with an angle less than 90°, to the direction of gravity.

The discharge element allows for the bulk material dispensed by the dispensing device to be reliably fed into a downstream process. For example, the bulk material can be fed to an extruder in a dosed manner.

At the same time, the cleaning agent can also be reliably discharged from the dispensing device via the discharge element.

Alternatively or in addition, it may be provided that the discharge element has a suction opening for the extraction of a fine fraction, in particular dust, and/or that the suction opening and/or the discharge opening is or can be operatively connected to a suction device for extracting dust.

In this way, a surprisingly simple yet reliable way was created to hit a fine fraction of the cleaning agent, such as bulk material residues, during the cleaning process.

If, for example, the cleaning agent is granular, the cleaning agent can be guided downwards via the discharge element through and along the direction of gravity during the cleaning process, and dust components and/or powdery bulk material residues can be at least partially extracted from the dispensing device via the suction opening.

Alternatively or additionally, it can also be provided that the suction opening points upwards against the direction of gravity.

This is a particularly simple yet reliable way to ensure that no or as little cleaning agent as possible, especially in granular form, reaches the suction unit during cleaning.

Alternatively or in addition, it may be provided that the conveying device is part of a dispensing device, such as a differential proportioning scale.

The functionality of a differential proportioning scale is generally known to those skilled in the art. The differential proportioning scale advantageously has at least one weight sensor, such as at least one load cell, so that the weight of a weighed system can be measured at different times. The weight difference at two consecutive points in time can be used to determine the amount of bulk material discharged. This value, in turn, can be used as part of a control loop to discharge a certain amount of bulk material per unit of time from the dispensing device, i.e., to dose the bulk material to be dispensed. Advantageously, the weighed system comprises at least the pick-up unit with the bulk material to be dispensed therein and, preferably, also the discharge area and/or the discharge element.

The object is achieved by the invention according to a third aspect by proposing a system comprising a conveying device according to the first and/or second aspect of the invention and at least one extruder, wherein preferably (i) the extruder is provided in the main conveying direction downstream of the device, in particular the pick-up unit, the discharge opening and/or the discharge element, and/or (ii) that bulk material can be fed from the conveying device, in particular in a dosed manner, to the extruder, in particular via the discharge element.

It was surprisingly recognized that with such a system it is particularly advantageous that the cleaning agent used to clean the conveying device can also be used to rinse the extruder. In particular, this can be done in a single operation by feeding the cleaning agent directly to the extruder after it has been discharged from the conveying device via the discharge element, for example. Therefore, the bulk material to be dispensed by the conveying device can be advantageously fed directly into an extruder holder for feeding bulk material to the extruder (and then the cleaning agent in the same way).

The extruder is therefore advantageously coupled with the conveying device in terms of process technology, in particular the extruder is downstream of the conveying device or dispensing device in the process chain.

This makes it particularly easily and quick to change the bulk material, as the cleaning of the conveying device or dispensing device and extruder (i.e., especially the parts in contact with the bulk material) can be carried out very easily and reliably. Consequently, the proposed system is particularly efficient and economical to operate even with different bulk materials. The possibility of a quick change of bulk material enables a particularly high utilization of the system.

For the other advantages associated with this, reference can be made to the previous observations on the first and second aspects of the invention. These also apply here accordingly.

The object is achieved by the invention according to a fourth aspect by proposing a closure means, in particular a lid, for closing a main opening of a pick-up unit of a dispensing device according to the first and/or second aspect of the invention, wherein a nozzle in the form of the additional nozzle of the dispensing device is arranged on or in the closure means.

By providing a closure means with a corresponding additional nozzle, an existing dispensing device can also be retrofitted in a surprisingly simple manner with functionality for efficient cleaning, in particular of a pick-up unit.

As to the advantages associated with this, reference can be made to the previous observations on the first and second aspects of the invention. These also apply here accordingly.

The object is achieved by the invention according to a fifth aspect by proposing a bearing element for bearing a discharge element of a conveying device according to the first and/or second aspect of the invention, wherein a nozzle of the conveying device is arranged on or in the bearing element.

By providing a bearing element with a corresponding radially and/or axially arranged nozzle or nozzles, an existing conveying device can also be retrofitted in a surprisingly simple manner with functionality for efficient cleaning, particularly of a discharge area.

The object is achieved by the invention according to a sixth aspect by proposing the use of a cleaning agent, in particular a granular cleaning agent, such as cleaning granules, for cleaning at least some parts and/or areas of a conveying device which are in contact with or can be brought into contact with a bulk material to be dispensed during the conveying or dispensing operation of the device, such as at least a pick-up unit suitable for receiving bulk material of the conveying device, in particular an inner surface of the pick-up unit, and for cleaning and/or rinsing an extruder downstream of the conveying device along a main conveying direction in a single operation.

It was surprisingly recognized that a particularly simple and economical cleaning of a conveying device and an extruder, which is advantageously filled or can be filled with a bulk material by the conveying device, is possible by using the cleaning agent both to clean the conveying device, for example to remove settled and/or adhering bulk material residues, as well as to clean and/or rinse the extruder.

Furthermore, the technical object described above is achieved by a method according to claim 17. In the method of cleaning a conveying device, in particular a conveying device as described above, at least parts of the bulk material residues that have settled on and/or adhered to an inner surface of the pick-up unit or the discharge area of the conveying device are removed and/or transported in the direction of the discharge opening by creating a fluid flow within the discharge area, the pick-up unit and/or a coupling area of the discharge element, at least in certain areas.

Advantageously, the fluid flow removes bulk material residues, especially from dead spaces, in the discharge area, storage area or coupling area.

Furthermore, the method for cleaning a conveying device, which conveying device has a pick-up unit for picking up bulk material to be dispensed, which can preferably be fed to the pick-up unit via a bulk material feed opening and/or can be relocated from the pick-up unit via a bulk material outlet opening in the direction of a discharge opening of the device along a main conveying direction, provides that at least parts of bulk material residues settled on and/or adhering to an inner surface of the pick-up unit are removed and/or transported in the direction of the bulk material outlet opening of the pick-up unit by forming a fluid flow, which is directed downwards at least in some areas, as a cleaning fluid flow, at least within the pick-up unit, at least in some areas.

By forming the fluid flow accordingly, the bulk material residues can be removed from the pick-up unit particularly efficiently and discharged from the dispensing device.

In addition, all options mentioned in the examples of the aforementioned aspects of the invention can be provided individually and in any combination in the method, unless the context indicates otherwise. In particular, the physical features of the conveying device described there can also be provided here for the conveying device. The features for which the conveying device or parts thereof are set up and/or designed may also be provided as features of the method.

Alternatively or in addition, it can also be provided that the cleaning fluid flow is formed in the manner of a cyclone.

Alternatively or in addition, it may also be provided that the cleaning fluid flow within the pick-up unit is formed along a flow path, wherein preferably the flow path runs at least in sections and/or at least in some areas along a spiral path, in particular with a decreasing diameter, and/or from top to bottom with respect to the direction of gravity.

Alternatively or in addition, it may also be provided that the fluid flow is introduced into the pick-up unit by a fluid jet expelled from an additional nozzle, and wherein the fluid jet is preferably directed at an angle against an inner surface of the pick-up unit, preferably at least partially deflecting the fluid flow in a circumferential direction of the pick-up unit.

The impact area of the inner surface can be the impact area described above.

Alternatively or in addition, it may also be provided that an interaction between the fluid jet and/or the fluid flow and the inner surface of the pick-up unit within at least parts of the pick-up unit will form a fluid flow in the manner of a cyclone.

Alternatively or in addition, it may also be provided that a cleaning agent, in particular a granular cleaning agent, such as cleaning granules, is supplied to the fluid flow, which is preferably transported by the fluid flow at least temporarily and/or at least partially along the inner surface of the pick-up unit, and that in particular bulk material residues are thereby removed from the inner surface.

For example, the cleaning agent can be fed to the pick-up unit via the cleaning agent feed opening and/or bulk material feed opening.

Alternatively or in addition, it can also be provided that the cleaning agent is supplied to the fluid flow at a distance from the additional nozzle.

For example, the additional nozzle can be provided at a distance from the cleaning agent feed opening.

Alternatively or additionally, it may also be provided that the cleaning granules are fed into the fluid flow through the same opening through which the bulk material is fed to the pick-up unit.

Alternatively or in addition, it may also be provided that the cleaning agent is fed into the fluid flow after the cyclone has formed stably.

Alternatively or in addition, it may also be provided that the cleaning agent is introduced into the pick-up unit together with the fluid jet as a mixture, in particular as a fluid-cleaning agent mixture, in particular via the additional nozzle.

Alternatively or in addition, it may also be provided that the cleaning agent and a fine fraction are separated from each other after exiting the conveying device, in particular by extracting the fines and/or ejecting the cleaning granules parallel or inclined to the direction of gravity.

In this regard, reference can also be made to the observations above.

Alternatively or in addition, it may also be provided that the cleaning agent exiting the conveying device is used to flush an extruder downstream of the conveying or dispensing device in the main direction of conveying, in particular by passing the cleaning agent exiting from the conveying device through the extruder.

Alternatively or in addition, it may also be provided that the device has at least one discharge area which follows the pick-up unit in the main direction of conveying and/or in which bulk material can be relocated from the pick-up unit, in particular via the bulk material outlet opening of the pick-up unit, and has a discharge element provided within the discharge area for discharging the bulk material from the discharge area in the direction of a discharge opening of the device,
wherein, preferably, in particular at the same time as or before or after the formation of a cleaning fluid flow in the pick-up unit, (i) a fluid is blown from a nozzle into the discharge area, in particular into an area existing around the discharge element, such as in an area in the gravitational direction below the discharge element, and/or (ii) a fluid is blown from a nozzle into a coupling area, in which coupling area the discharge element is connected to a drive element, such as a drive shaft.

In one embodiment, it may also be advantageous that the device is set up to actuate, in particular rotate, the discharge element at least temporarily by means of a nozzle during the ejection of a fluid jet. In this way, a beneficial cleaning effect was also observed in respect of the pick-up unit alone.

A fluid, in particular from a second nozzle, can be blown into the discharge area, in particular into an area existing around the discharge element, such as in an area in the direction of gravity below the discharge element, and/or a fluid can be blown into a coupling area in which coupling area the discharge element is connected to a drive element, such as a drive shaft.

This is based on the surprising realization that even areas of the dispensing device that are difficult to access can be cleaned of bulk material residues by blowing a fluid into the discharge area and/or coupling area, thereby removing the stuck bulk material.

This makes the cleaning process particularly efficient and cost-effective. It is therefore no longer necessary to disassemble the dispensing device in order to be able to clean hard-to-reach areas.

Above all, it was surprisingly recognized that the discharge element can advantageously remain installed during cleaning and can be used to swirl the introduced fluid flow. The cleaning effect can thereby be surprisingly significantly increased by the presence of the discharge element.

In addition, impairments of the discharge element, also and especially in the coupling area, by stuck bulk material can be avoided or at least reduced by providing one or more of the proposed first and second nozzles.

It was also recognized that the use of the fluid flow(s) together with the cleaning fluid flow leads to surprising synergies. Thus, the combined use made it possible to obtain a cleaning result that is better than that possible with sequential use of the individual fluid flows.

In addition, the method of the invention provides that the bulk material feed opening, the discharge element of the conveying device, the nozzle or nozzles, the additional nozzle or nozzles, the cleaning agent feeding device, the extruder and/or the suction device are controlled individually and in a defined chronological sequence.

As a result, mechanical discharge movements through discharge elements and fluid flows for the discharge of bulk material residues and, if necessary, extraction processes can be coordinated in terms of timing and logic in order to achieve the best cleaning results depending on the type of bulk material.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a schematic representation of a conveying device according to the invention;

FIG. 1b shows a schematic view of the conveying device from FIG. 1a;

FIG. 1c shows a schematic representation of a pick-up unit of the conveying device from FIG. 1a with a sketched cleaning fluid flow in the manner of a cyclone;

FIG. 1d shows a schematic representation of a coupling area of the conveying device from FIG. 1a;

FIG. 2 shows a schematic representation of an example of a conveying device according to the invention; and

FIG. 3 shows a schematic representation of a system according to an aspect of the invention.

### DETAILED DESCRIPTION

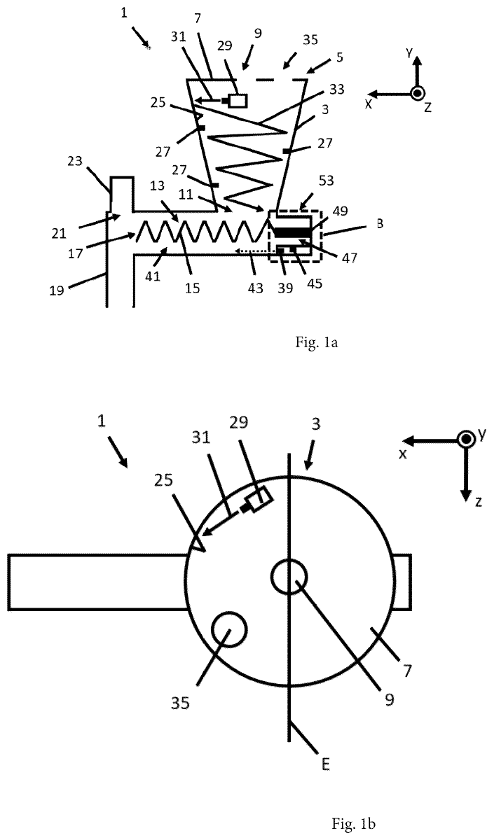

FIG. 1a shows a schematic representation of a conveying device 1 according to one aspect of the invention. In FIG. 1b, the conveying device 1 is shown in a schematic manner from above.

The conveying device 1 has a pick-up unit 3, the main opening of which 5 can be closed with a removable lid 7. In the pick-up unit 3, a bulk material to be conveyed or dispensed by the conveying device 1 may be received, which can be fed into the pick-up unit 3 via a bulk material feed opening 9 provided in the lid 7. The pick-up unit 3 is conically shaped and has an inner diameter decreasing in the direction of gravity (which runs along the negative Y-axis in FIG. 1a). Opposite and in the direction of gravity below the bulk material feed opening 9 is a bulk material outlet opening 11.

Bulk material can be relocated from the pick-up unit 3 to a discharge area 13 of the device 1 via the bulk material outlet opening 11. Within the discharge area 13, a discharge element 15, in this case in the form of a spiral, is provided for discharging the bulk material from the discharge area 13 in the direction of a discharge opening 17.

The discharge opening 17 ends in a vertical discharge 19. The vertical discharge 19 allows for bulk material to be discharged from the conveying device 1 parallel to the direction of gravity. The vertical discharge 19 has a suction opening 21 which is in active contact with a suction device 23 for extracting dust.

During the conveying or dispensing operation of the device 1, i.e., during the conveying of bulk material, residues 27 of the bulk material to be dispensed may settle on and/or adhere to an inner surface 25 of the discharge area 13 and/or to the pick-up unit 3, as well as to other parts of the device 1. In the event of a planned change of bulk material type, these bulk material residues 27 can lead to undesirable cross-contamination and must therefore be removed first.

Therefore, in order to be able to clean the device 1 in the event of an upcoming change of bulk material type, for example, the conveying device 1 has a large number of nozzles 29, 39, 45, 52.

A fluid jet 43 can be ejected from a nozzle 39 located in the coupling area 47 into a dead space 41 below a discharge element 15. This fluid jet 43 is aligned parallel to a longitudinal axis of the discharge element 15. To be more precise, with the second nozzle 39, the fluid 43 can be ejected along one direction perpendicular to the direction of gravity, parallel to the main extension direction of the discharge element 15 (i.e., along a direction parallel to the X-axis).

On the one hand, it is suitable for discharging bulk material from a coupling area 47 or storage area of the discharge element, which is usually difficult to access. On the other hand, the same fluid jet 43 can remove bulk material from the dead space between the discharge element 15 and the housing wall of the discharge area 13.

From the additional nozzle 29, a fluid jet 31 can be ejected into the pick-up unit 3. The additional nozzle 29 is aligned in such a way that the inner surface 25 of the pick-up unit 3 can be flowed against at least in part with the ejected fluid jet 31, so that at least within the pick-up unit 3 a fluid flow in the manner of a cyclone can be formed as a cleaning fluid flow, at least in some areas. The device 1 is therefore designed in particular for the purpose of the ejected fluid jet 31 interacting with the inner surface 25 in such a way that the said cleaning fluid flow is formed.

As can be seen in particular in FIG. 1b, an area of the inner surface 25 is flowed against obliquely (along a curvature of the inner surface 25 running along a circumferential direction of the pick-up unit 3) by the ejected fluid jet 31. (Of course, in FIG. 1b, the nozzle 27 and the fluid jet 29 as well as the inner surface are not visible due to the closed lid. However, this has been disregarded here for illustrative reasons.)

Due to the conical shape of the pick-up unit 3, the fluid flow is forced onto a spiral path 33 with a decreasing diameter. As a result, the speed of the fluid flow increases steadily. In particular, the interaction between the ejected fluid jet and the pick-up unit (especially the curved inner surface) creates a vortex flow. This cleaning fluid flow makes it particularly easy to remove bulk material residues 27 from the inner surface of the pick-up unit.

In the lid 7 of the pick-up unit 3, a cleaning agent feed opening 35 is provided, through which a cleaning agent can be fed into the interior of the pick-up unit 3. This makes it possible, especially after a cyclone has been formed within the pick-up unit 3, to feed the cleaning agent to the cleaning fluid flow. For example, the cleaning agent can be in granular form and be carried along the spiral track 33 at times and/or in sections by the cleaning fluid flow. The cleaning agent can also reliably remove more strongly adhering bulk material residues 27 from the inner surface 25.

The cleaning agent feed opening 35 is located at a distance from the additional nozzle 29, wherein both the additional nozzle 29 and the cleaning agent feed opening 35 are offset from a vertical central plane of the pick-up unit 3 (as can be defined in FIG. 1b, for example, by plane E).

FIG. 1c shows a schematic representation of the pick-up unit 3 of the dispensing device 1 with a sketched fluid flow in the manner of a cyclone. The viewing direction is from above onto the pick-up unit 3, wherein the view into the interior of the pick-up unit 3 is unobstructed, at least with regard to the fluid flow. In addition, the particles 37 of the cleaning agent are shown, which are carried by the cleaning fluid flow on the downward spiral path 33 (and at least partially along the inner surface 25).

In the case of a powdered bulk material, for example, the bulk material residues 27 are whirled up by the cleaning fluid flow and, due to their inertia and/or after completion of the supply of the fluid jet, settle in the discharge area 13 of the device 1, from where they can be removed from the device 1, for example suctioned off. For example, the suction device 23 can suction a dust component upwards, while the cleaning agent in the discharge 19 falls downwards (i.e., along the direction of gravity).

Usually, the whirled up or loosened bulk material is discharged from the device 1 via the discharge opening 17, in particular suctioned off. The fluid 43 ejected from the nozzle 39 can be additionally swirled by the discharge element 15, so that the movement of the discharge element 15 additionally supports the cleaning effect of the fluid 43.

In addition, the conveying device 1 also has a nozzle 45 for blowing fluid into a coupling area 47 in which the discharge element 15 is connected to a drive element 49 (such as a drive shaft). Bulk material accumulated within the coupling area 47 cannot be relocated by the discharge element 15, i.e., it remains within the device 1 without additional measures. By blowing in fluid 51 within the coupling area 47, bulk material located there can be whirled up and/or discharged from the device 1 via the discharge opening 17, in particular suctioned off.

Both nozzle 39 and nozzle 45 are located in a bearing element 53 for bearing the discharge element 15, which also contains the coupling area 47. FIG. 1d shows a more detailed schematic representation of the area B of the device 1 marked in FIG. 1a. It mainly shows the bearing element 53 including the coupling area 47 and nozzle 39 and nozzle 45.

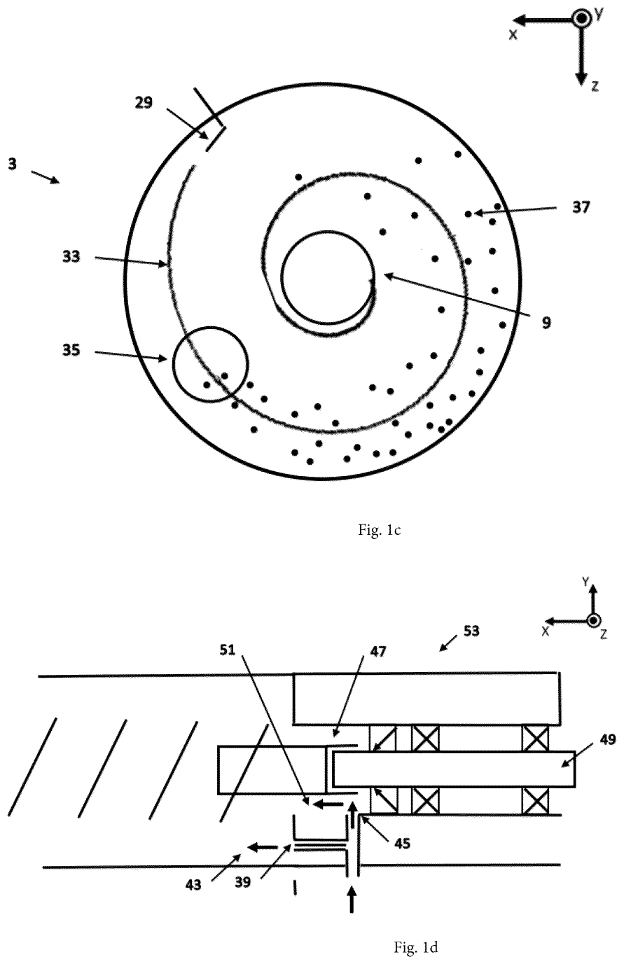

FIG. 2 shows a schematic representation of an example of a conveying device according to the invention.

The discharge element 15 shown in FIG. 2 shows a screw conveyor with a shaft 16 in the form of a hollow shaft. The hollow shaft has several nozzles 52 which eject a fluid flow 53 in a radial direction to the shaft 16. In this case, the nozzles 52 are arranged in the main extension direction of the screw conveyor and in the circumferential direction of the shaft 16 at a distance from each other. Advantageously, the screw conveyor rotates while the fluid 53 flows out, so that in the case of a trough-shaped discharge area 13, the area below the screw conveyor is whirled up and blown out. The shaft 16 of the screw conveyor is equipped with a connection for the fluid 52 in the bearing or coupling area 47.

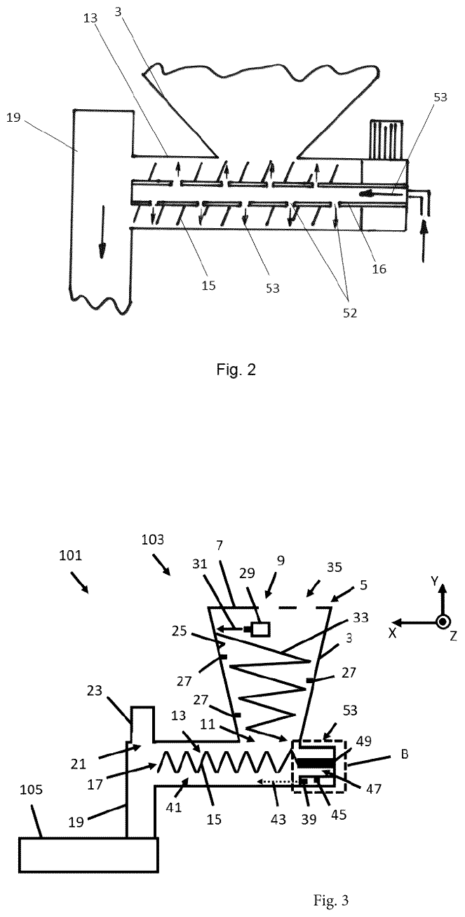

FIG. 3 shows a schematic representation of a system according to another aspect of the invention.

The system 101 has a conveying device 103 according to the first aspect of the invention. For example, it can be the conveying device 1 discussed in respect of FIGS. 1a-1d. Therefore, the features of the conveying device 103 are provided by way of example with the reference signs of the conveying device 1 discussed in respect of FIGS. 1a-1d.

In addition, the system 101 has an extruder 105. Bulk material from the conveying device 103 can be fed to the extruder 105 via the vertical ejection.

After cleaning the conveying device 103, the cleaning agent can be fed to the extruder 105 in the system 101 and used to flush the extruder 105 there. This means that both reliable cleaning of the conveying device 103 and flushing of the extruder 105 are possible in a single operation.

The features disclosed in the preceding description, drawings and claims may be essential for the invention in its various embodiments, either individually or in any combination.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conveying device for bulk material, the conveying device comprising:
at least one pick-up unit to pick up bulk material to be dispensed;
at least one discharge area arranged downstream of the pick-up unit in a main conveying direction and/or into which bulk material is adapted to be relocated from the pick-up unit via a bulk material outlet opening of the pick-up unit;
a discharge element provided within the discharge area to discharge the bulk material from the discharge area in a direction of a discharge opening of the conveying device; and
at least one nozzle for blowing fluid into an area around the discharge element.

2. The conveying device according to claim 1, wherein the nozzle is provided for blowing fluid into a coupling area, in which coupling area, the discharge element is connected to a drive element or a drive shaft, or is provided for blowing fluid into a dead space below the discharge element, or is provided for blowing fluid into a radially existing area between a shaft of the discharge element and an inner surface of a housing forming the discharge area.

3. The conveying device according to claim 1, wherein the nozzle is arranged on or in a bearing element for bearing the discharge element or in the coupling area.

4. The conveying device according to claim 1, wherein the nozzle is arranged on or in a shaft or a hollow shaft of the discharge element.

5. The conveying device according to claim 1, wherein the fluid is ejected by the nozzle along a direction substantially perpendicular to a direction of gravity or substantially parallel to the main extension direction of the discharge element.

6. The conveying device according to claim 1, wherein the fluid is adapted to be ejected with the nozzle along a direction substantially perpendicular to the main extension direction of the discharge element and/or deflected in a direction substantially parallel to the main extension direction.

7. The conveying device according to claim 1, wherein the fluid is adapted to be ejected with the nozzle along a direction radial to the main extension direction of the discharge element.

8. The conveying device according to claim 1, further comprising at least one additional nozzle for at least temporarily ejecting a fluid jet into the pick-up unit, wherein the additional nozzle is aligned such that an inner surface of the pick-up unit flows against the fluid jet, at least in some areas, to form a fluid flow in a manner of a cyclone as a cleaning fluid flow.

9. The conveying device according to claim 1, wherein the pick-up unit has a lid or a removable lid, and wherein a bulk material feed opening is provided in the lid and/or wherein the pick-up unit is designed in a rotationally symmetrical manner at least in some areas.

10. The conveying device according to claim 1, wherein the pick-up unit has, at least in sections, a diameter tapering along a direction of gravity or an inner diameter.

11. The conveying device according to claim 1, wherein the additional nozzle is aligned relative to the pick-up unit or to the inner surface of the pick-up unit such that the fluid jet that is adapted to be ejected from the additional nozzle is deflected via an impact area of the inner surface of the pick-up unit.

12. The conveying device according to claim 1, wherein the additional nozzle is arranged on the lid of the pick-up unit such that, when the lid is closed, the additional nozzle protrudes at least partially into the pick-up unit.

13. The conveying device according to claim 1, wherein the device comprises a storage container for receiving a cleaning agent or a granular cleaning agent or cleaning granules, and/or is connected or connectable with the storage container.

14. The conveying device according to claim 1, further comprising a cleaning agent feed opening for feeding a cleaning agent into the interior of the pick-up unit.

15. The conveying device according to claim 1, wherein the discharge opening terminates into a discharge element, wherein bulk material is adapted to be discharged from the conveying device via the discharge element in a direction substantially parallel or inclined to a direction of gravity and/or wherein the discharge element has a suction opening for extracting a fine fraction and/or wherein the suction opening and/or the discharge opening is adapted to be brought into active connection with a suction device for extracting dust.

16. A system comprising:
the conveying device according to claim 1; and
at least one extruder arranged in a main conveying direction downstream of the conveying device,
wherein the pick-up unit, the discharge opening, and/or the discharge element, and/or bulk material from the conveying device, are adapted to be fed in doses to the extruder via the discharge element.

17. A method for cleaning a conveying device according to claim 1, the method comprising:
removing at least parts of bulk material residue settled on and/or adhering to an inner surface of the pick-up unit or the discharge area; and
conveying in a direction of the discharge opening the removed parts of the bulk material by forming a fluid flow as a cleaning fluid flow within the discharge area, the pick-up unit, and/or a coupling area of the discharge element, at least in some areas.

18. The method according to claim 17, wherein bulk material residues from dead spaces are removed by the fluid flow in the discharge area.

19. The method according to claim 17, wherein the cleaning fluid flow is formed in the manner of a cyclone, wherein the fluid flow is introduced into the pick-up unit by a fluid jet ejected from an additional nozzle, wherein the fluid jet is directed obliquely against an inner surface of the pick-up unit and at least partially deflects the fluid flow in a circumferential direction of the pick-up unit, wherein an interaction between the fluid jet and/or the fluid flow and the inner surface of the pick-up unit within at least parts of the pick-up unit creates a fluid flow in the manner of a cyclone, wherein a cleaning agent or a granular cleaning agent or cleaning granules is fed into the fluid flow, which is transported by the fluid flow at least temporarily and/or at least partially along the inner surface of the pick-up unit and the bulk material residues are thereby removed from the inner surface, wherein the cleaning agent is fed into the fluid flow after the cyclone has formed stably, wherein the cleaning agent and a fine fraction are separated from each other after exiting the conveying device by extracting the fine fraction and/or discharging the cleaning granules parallel to or inclined to the direction of gravity, and/or wherein an extruder downstream of the conveying device in the main conveying direction is flushed with the cleaning agent exiting from the conveying device by passing the cleaning agent exiting from the conveying device through the extruder.

20. The method according to claim 17, wherein control of the bulk material feed opening, the discharge element of the conveying device, the nozzles, the additional nozzle, the cleaning agent feed device, the extruder and/or the suction device is provided in a defined chronological sequence.
